(19) United States
(12) Patent Application Publication
(10) Pub. No.: US 2013/0268583 A1
(43) Pub. Date: Oct. 10, 2013

(54) Hybrid Client-Server Graphical Content Delivery Method and Apparatus

(71) Applicants: Paul Edmund Fleetwood Sheppard, Glasgow (GB); Michael Athanasopoulos, Bradford (GB); Peter Jack Jeffery, Sheffield (GB)

(72) Inventors: Paul Edmund Fleetwood Sheppard, Glasgow (GB); Michael Athanasopoulos, Bradford (GB); Peter Jack Jeffery, Sheffield (GB)

(73) Assignee: TANGENTIX LTD., Sheffield (GB)

(21) Appl. No.: 13/856,348

(22) Filed: Apr. 3, 2013

(30) Foreign Application Priority Data
Apr. 4, 2012 (GB) 1206059.6

(51) Int. Cl. H04L 29/06

(52) U.S. Cl. CPC H04L 29/06047
USPC 709/203

(57) ABSTRACT

A hybrid client-server multimedia content delivery system is provided for delivering graphical information across a network from a server to a client device. An initial set of object data is provided sufficient for the client device to begin representing the virtual environment, followed by one or more subsequent items of the object data dynamically while the client device represents the virtual environment on the visual display device. The server maintains shadow rendering information identifying the items of object data which are currently in use at the client device. Delivery of subsequent object data to the client device is ordered and prioritised with reference to the shadow rendering information.

### RELATED APPLICATIONS

This application claims priority from foreign application GB 1206059.6 filed Apr. 4, 2012 in the United Kingdom, and which is expressly incorporated herein by reference in its entirety.

### BACKGROUND

1. Technical Field

The present inventive concept relates generally to the field of systems for delivering multimedia content, and more particularly, but not exclusively, to a method and apparatus for delivering graphical information across a network between a server and a client device.

2. Description of Related Art

It is desired to deliver rich and entertaining multimedia content to users across a network such as the Internet. However, there are technical restrictions concerning the transmission of data, including particularly the caching or local storage of content items, efficient consumption of available bandwidth, and timing factors such as latency and delay. Also, there are difficulties regarding capabilities of the hardware devices that supply and receive the multimedia content, such as the need for specialised graphics hardware, including particularly a dedicated graphics processing unit (GPU), and limitations on delivering content to multiple users simultaneously from the same source hardware.

In general terms, it is well known to deliver multimedia content from a server device to a client device over a network. FIG. 1 shows various example network architectures of the related art. As well as delivering pre-made movies or other content that can be prepared in advance, it is also now desired to deliver interactive content such as games and games programs to be actively played on a client device. However, games generally are more technically challenging, because the game should respond to actions and commands by the user and each game session is usually unique to that user.

FIG. 1A is an example of delivering audio and video (AV) data content 11 by streaming from a server device 10 to a client device 20 over a network 30. The client device 20 can begin playback of initial portions 12 of the AV data, i.e. begin playing a video clip or movie, while still receiving other portions of the AV data to be played later. This AV data 11 typically includes two-dimensional moving image data as 2D video data. Many encoding and compression schemes have been developed in recent years, such as MPEG, to reduce the bandwidth required to carry such AV data and improve delivery of the content.

FIG. 1B shows another traditional architecture wherein an interactive content 13 (e.g. a game), comprising both multimedia content assets 14 and executable application code or game code 15, is delivered on a physical carrier 16 such as a CD or DVD optical disc, which the user must purchase and physically transport to a client device 20. Typically, the purchased game can be supplemented with additional downloadable content 17 from the server 10, such as additional characters, levels or missions. The additional content 17 can be delivered across the network 30, either as a download package or by streaming.

FIG. 1C shows another example architecture to deliver the entire package of interactive content 13 to the client device 20 across a network 30 to be held on a local storage device 21. Delivering the whole game takes a long time, but has proved to be an acceptable approach in some commercial systems. Within such a ‘full package’ system, the application code (game code) 15 can be streamed, so that game play can begin while later sections of a game are still being downloaded. In this case, the game code 15 runs on the client device 20 and the graphical data is rendered at the client device 20, which means that the client device 20 must be relatively powerful and resourceful, like a PC or games console.

FIG. 1D illustrates yet another example architecture, which provides a centralised game server 10A running the game code 15 using a relatively powerful graphics processor (GPU) 18, and to generate a relatively lightweight stream of AV data 19 for delivery to the client device 20 (i.e. a 2D video stream similar to FIG. 1A). This cloud-gaming architecture allows a greater range of client devices to participate in the consumption of rich, interactive multimedia content, because only relatively lightweight 2D video handling is required at the client device 20. Meanwhile, complex 3D graphical processing is performed at the server 10 to determine responses in the game according to user inputs. However, games and games programs generally place intensive demands on the underlying hardware and network infrastructure. For example, peak bandwidth consumption in some systems can reach 1 Gb per second. Online cloud-based gaming architectures based on video streaming place significant workload on the central server, and this workload increases yet further when serving tens or thousands of individual client devices.

It is now desired to provide a multimedia content delivery system which addresses these, or other, limitations of the current art, as will be appreciated from the discussion and description herein. In particular, it is desired to develop other approaches to delivering multimedia content across a network between a server device and a client device.

### SUMMARY OF THE INVENTION

According to the present invention there is provided a system and method as set forth in the appended claims. Other features of the invention will be apparent from the dependent claims, and the description which follows.

The example architecture discussed herein has many advantages, as will be explained in more detail below. In one aspect, the example system provides efficient bandwidth consumption, thereby enabling delivery across a wider range of networks. In one aspect, the example system reduces start-up delays, so that a user is able to start interacting with the game with minimal waiting. In one aspect, the example system reduces latency, thereby reducing a delay between a user making an input and seeing a result on the display screen. In one aspect, these and other advantages are realised by efficiently managing the delivery of 3D graphical objects to the client device.

A hybrid client-server multimedia content delivery system is provided for delivering graphical information across a network from a server to a client device. An initial set of object data (e.g. geometry and/or textures) is provided sufficient for the client device to begin representing the virtual environment. The initial set is followed over time by one or more subsequent items of the object data, with the subsequent items preferably being provided dynamically while the client device represents the virtual environment on a visual display device. The server maintains shadow rendering information which identifies the object data that is currently being used to render the virtual environment at the client device, i.e. which of the provided geometries and textures are currently needed at particular points in time. Delivery of the subsequent items of object data to the client device is then ordered and prioritised with reference to the shadow rendering information, e.g. to supply new objects or to provide improved, higher-resolution, versions of previously delivered assets.

A method is provided for delivering graphical information across a network. The method may include providing an initial set of object data sufficient for a client device to begin representing a virtual environment. The initial set may be followed by one or more subsequent items of the object data dynamically while the client device represents the virtual environment on the visual display device. The method may include maintaining shadow rendering information at a server which identifies the object data that is currently being used to present the virtual environment at the client device. The method may include determining a relative priority of the one or more subsequent items of object data which are to be delivered to the client device with reference to the shadow rendering information.

A tangible non-transient computer readable medium is provided having recorded thereon instructions which, when executed, cause a computer to perform the steps of any of the methods defined herein.

### BRIEF DESCRIPTION OF THE DRAWINGS

For a better understanding of the invention, and to show how example embodiments may be carried into effect, reference will now be made to the accompanying drawings in which:

FIGS. 1A-1D are schematic diagrams of multimedia content delivery systems in the related art;

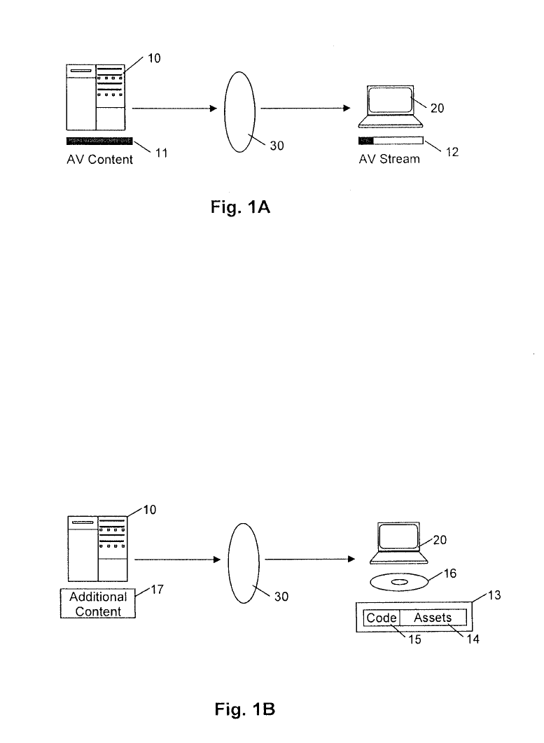

FIG. 2 is a schematic diagram showing an example multimedia content delivery system;

FIG. 3 is a schematic diagram showing the example multimedia content delivery system in more detail;

FIG. 4 is a schematic view showing an example client device;

FIG. 5 is a schematic diagram showing an example hybrid multimedia content delivery system;

FIG. 6 is a schematic diagram illustrating an example object transformation mechanism;

FIG. 7 is a schematic diagram further illustrating an example secure multimedia content distribution system; and

FIG. 8 is a schematic diagram showing an example mechanism for managing bandwidth.

### DETAILED DESCRIPTION OF THE EXAMPLE EMBODIMENTS

The example embodiments will be discussed particularly with reference to a gaming system, for ease of explanation and to give a detailed understanding of one particular area of interest. However, it will be appreciated that other specific implementations will also benefit from the principles and teachings herein. For example, the example embodiments can also be applied in relation to tools for entertainment, education, engineering, architectural design and emergency planning. Other examples include systems providing visualisations of the human or animal body for teaching, training or medical assistance. There are many specific environments which will benefit from delivering rich and involving interactive multimedia content.

Generally, these 3D graphical elements represent an object as a geometric structure (such as a polygonal wire-frame geometry or mesh) with an overlying surface (texture). The 3D object data is then reconstructed by a renderer at the client device, to produce video images for a display screen. In the example gaming system, the video images are then typically output in combination with a coordinated audio stream comprising background music and environmental audio (wind, rain), and more specific game-event related audio effects (gunshot, footfalls, engine noise).

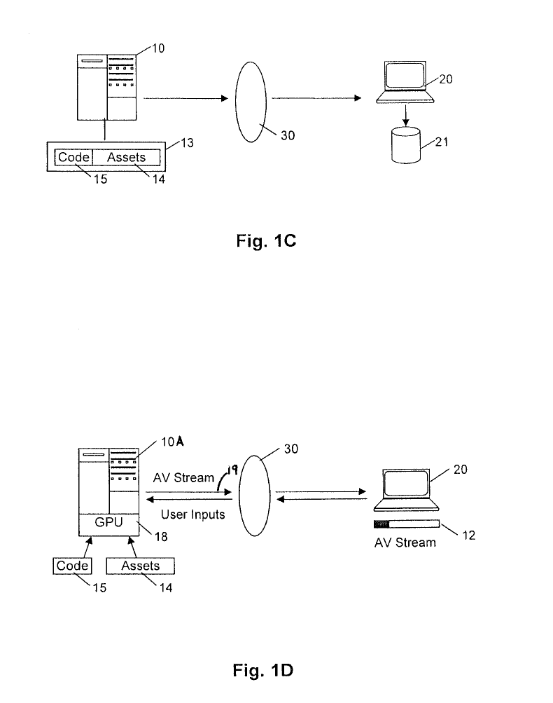

FIG. 2 is a schematic diagram of an example multimedia content delivery system for delivering graphical information across a network. This graphical information may include 2D data, 3D data, or a combination of both 2D and 3D data. Generally, 2D data is defined relative to a plane (e.g. by orthogonal x & y coordinates) while 3D data is defined relative to a volume (e.g. using x, y and z coordinates).

The example content delivery system includes at least one server device 100 and at least one client device 200 which are coupled together by a network 30. The underlying software and hardware components of the server device 100, the client device 200 and the network 30 may take any suitable form as will be familiar to those skilled in the art. Typically, the server devices 100 are relatively powerful computers with high-capacity processors, memory, storage, etc. The client devices 200 may take a variety of forms, including hand-held cellular phones, PDAs and gaming devices (e.g. Sony PSP™, Nintendo DS™, etc.), games consoles (XBOX™, Wii™, PlayStation™), set-top boxes for televisions, or general purpose computers in various formats (tablet, notebook, laptop, desktop). These diverse client platforms all provide local storage, memory and processing power, to a greater or lesser degree, and contain or are associated with a form of visual display unit such as a display screen or other visual display device (e.g. video goggles or holographic projector). The network 30 is suitably a wide area network (WAN). The network 30 may include by wired and/or wireless connections. The network 30 may include peer to peer networks, the Internet, cable or satellite TV broadcast networks, or cellular mobile communications networks, amongst others.

In one example embodiment, the server 100 and the client device 200 are arranged to deliver graphical information across the network 30. In the following example, the graphical information is assumed to flow substantially unidirectionally from the server 100 to the client 200, which is generally termed a download path. In other specific implementations, the graphical information is transmitted from the client 200 to be received by the server 100, which is generally termed an upload path. In another example, the graphical information is exchanged bidirectionally.

A key consideration is that the bandwidth across the network 30 may be limited or otherwise restricted. There are many limitations which affect the available bandwidth for communication between the sever 100 and the client device 200 on a permanent or temporary basis, as will be well known to those skilled in the art, such as the nature of the network topography (wireless vs. wired networks) and the transmission technology employed (CDMA vs. EDGE), interference, congestion and other factors (e.g. rapid movement of mobile devices, transition between cells, etc). Therefore, as will be discussed in more detail below, the example embodiments allow effective use and management of available bandwidth even when transmitting highly detailed graphical information. Further, it is desired to manage the bandwidth to minimise or reduce latency or delay. Security is another important consideration. In particular, it is desired to inhibit unauthorised copying of the graphical information. Therefore, as will be discussed in more detail below, the example embodiments provide effective security for transmitting sensitive graphical information across a network.

Hybrid System Architecture

In this example embodiment, the server 100 and the client device 200 cooperate to execute portions of application code (game code) to control a virtual environment that will be represented visually through the client device 200. Suitably, the server 100 receives data requests from at least one of the client devices 200, and the server 100 delivers relevant game data in real time to the client 200, which enables the client device 200 to output the visual representation on a display screen.

The server 100 manages an asset library or object library 450 comprising a large repository of game assets. The server 100 streams these assets from the library 450 across the network 30 to the client device 200 where they are stored in a client-side asset cache 245. The client 200 calls for assets according to a current progress of the virtual environment as managed by a client-side environment engine 260. Meanwhile, a server-side environment engine 150 likewise tracks progress within the same virtual environment and prepares the assets from the library 450 ready to be streamed to the client device 200.

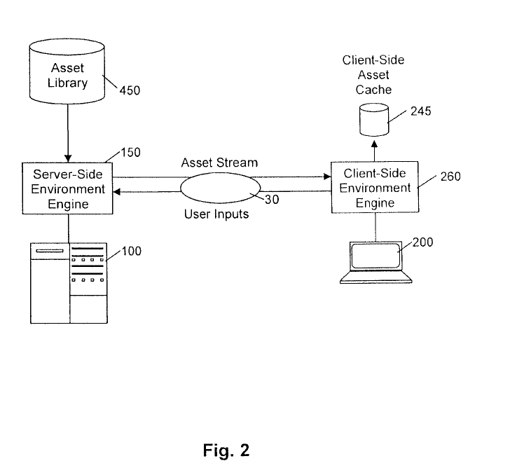

FIG. 3 shows the example system architecture in more detail. In the example general system architecture illustrated in FIG. 3, the server 100 may include a general infrastructure unit 101, an offline processing unit 102, and an online processing unit 103. Optionally, these units may be distributed amongst several server devices arranged at physically separate locations or sites. Also, these units may be duplicated or sub-divided according to the needs of a particular practical implementation.

The general infrastructure unit 101 provides support infrastructure to manage the content delivery process. For example, the general infrastructure unit 101 provides modules 101a-101d that manage user accounts including authentication and/or authorisation functions 101a, billing 101b, developer management interfaces 101c, and lobby services 101d that allow users to move around the system to access the available games or other multimedia content.

The example offline processing unit 102 may include an object transformation unit 400 that transforms complex 3D objects into a compressed format, as will be discussed in more detail below. The object transformation unit 400 suitably receives raw object data 310 and converts or transforms the object data into a transformed format as will be discussed below.

The object transformation unit 400 suitably operates statically, in advance, so that an object library 450 of objects becomes available in the transformed format. As one option, a games developer may supply 3D objects in a native high-resolution format such as a detailed polygon mesh. These objects represent, for example, characters or components of the game such as humans, animals, creatures, weapons, tables, chairs, stairs, rocks, pathways, etc. The object transformation unit 400 then transforms the received objects into the compressed format and provides the library 450 of objects to be used later. This, in itself, is a useful and beneficial component of the system and may have a variety of uses and applications.

The example online processing unit 103 interacts with the client devices 200 over the network 30 to provide rich and engaging multimedia content to the user. In the example embodiment, the system operates in real time so that user commands directly affect the multimedia content which is delivered onscreen to the user.

In the example embodiments, a server-side environment engine 150 runs on the server 100 with input commands from the client 200, and the server 100 then delivers the relevant graphics data in real-time to the client 200 for rendering and display by the client device 200. Further, the game code also runs on the client 200 which generates data requests to the server 100, and the server 100 then delivers the relevant graphics data to the client 200 for rendering and display by the client device 200.

Optionally, the online processing unit 103 includes a dynamic transformation unit 405, which may perform the object transformation function dynamically, e.g. while other data is being delivered to the client device 100. In the example gaming system, this architecture allows new compressed object data to be created even while the game is being played. These dynamically transformed objects are suitably added to the object library 450.

The online processing unit 103 suitably includes a data management module 120 and a server-side I/O handler 130. In the example gaming system, the data management module 120 handles the dispatch of game data to the client 200. As an example, the data management module 120 includes a bandwidth management component to ensure that the bandwidth available to serve the client 200 across the network 30 is not exceeded.

In the example embodiment, the client 200 includes, amongst other components, a graphics processor 230 and a client-side I/O handler 230. Here, the graphics processor 220 takes the 3D graphical data, received such as from the server 200 or elsewhere, and performs relatively intensive graphical processing to render a sequence of visual image frames capable of being displayed on a visual output device coupled to the client 200. These frames may be 2D image frames, or 3D image frames, depending on the nature of the visual output device. The client-side I/O handler 230 connects with the server-side I/O handler 130 as discussed above.

Server-Side Virtual Environment

In the example embodiment, the server 200 comprises the environment engine 150 which is arranged to control a remote virtual environment. In this case, the environment engine 150 is located remote from the client device 200. Suitably, this environment is to be populated with 3D objects taken from the object library 450 and/or generated and added to library 450 dynamically while the user navigates within the environment. In this example embodiment, the server 100 and the client device 200 cooperate together dynamically during operation of a game, to control and display the virtual environment through the client device 200.

Advantageously, the server 100 applies powerful compression to key graphical elements of the data, and the workload required to deliver the visual representation is divided and shared between the server 100 and the client 200. In particular, this workload division allows many hundreds or even many thousands of the client devices 200 to be connected simultaneously to the same server 100.

In this example embodiment, the workload is divided by sending, or otherwise delivering, compressed data associated with the graphics for processing and rendering in real time on the client 200, so that graphically-intensive processing is performed locally on the client device 200, while control processing of the virtual environment (such as artificial intelligence or “AI”) is performed on the server 100. The control processing suitably includes controlling actions and interactions between the objects in response to the user commands (e.g. a car object crashes into a wall, or one player character object hits another player character or a non-player character).

In the example gaming system, user commands generated within the client device 200 may take the form of movement commands (e.g. walk, run, dive, duck) and/or action commands (e.g. fire, cover, attack, defend, accelerate, brake) that affect the operation of the objects in the virtual environment. Suitably, these user commands are fed back to the server 100 to immediately update the game content being delivered onscreen at the client device 200. To this end, the server 100 includes the Input/Output (I/O) handler unit 130 to handle this return stream of user inputs sent from a corresponding client I/O handler unit 230 in the client device 200. This return stream of user input data may be delivered in any suitable form, depending upon the nature of the client device 200.

In an illustrative example, the environment engine 150 functions as a server-side game engine. Here, the server-side games engine 150 sits on the remote server 100 and deals with internal aspects of the game that do not require output to the client 200. When output to the client 200 is required, such as a graphics display or audio, then information or commands are sent to the client 200 for processing at the client 200. For example, the server 100 commands the client device 200 to retrieve and display a particular object at a particular position. In the example embodiments, the server-side environment engine 150 deals with the underlying artificial intelligence relevant to the game and determines how the output will change based on the inputs from the client 200. When output to the client is required, the server-side environment engine 150 makes a call to the games data management service 120 to handle the delivery of the data to the client 200. A new object may now be delivered to the client device 200, ideally using the compressed data format as discussed herein. Alternatively, the server 100 may deliver a reference to an object that has previously been delivered to the client device 200 or otherwise provided at the client device 200. Further, the server 100 may deliver commands or instructions which inform the client device 200 how to display the objects in the virtual environment.

Advantageously, in this example embodiment, the server 100 now has minimal need for processing graphics, which is instead performed on the client 200. Hence, the server 100 is able to be implemented using available standard server hardware for running the system. This is a key drawback of other approaches such as video streaming, which need investment in higher cost specialist server hardware for rendering the graphics and transforming it into the video stream.

The server 100 is also better able to service multiple clients 200 simultaneously. As one option, the server 100 virtualizes instances of the game engine 150, in order to maximize the number of instances of a game running on the physical server hardware. Off-the-shelf virtualization technologies are currently available to perform this task, but need adapting to the specifics of real-time games delivery. By contrast, the video streaming approach will often need to allocate the resources of a full server system to each user, because efficient graphics virtualization technology does not yet exist. Here, the example system virtualizes the game code on the server 100, whilst running the graphics on the client 200.

The system does not require a significant data download before the user can start playing their game. The game engine 150 is located on the remote server 100 and hence does not need to be transmitted or downloaded to the client 200. Also, the game engine 150 can be modified or updated on the server 100 relatively quickly and easily, because the game engine 150 is still under close control of the game service provider. By contrast, it is relatively difficult to update or modify a game engine that has already been distributed in many thousands of copies (e.g. on optical disks or as downloads to a local storage device) onto a large number of widely dispersed client devices (e.g. game consoles). Hence, this split processing between the server 100 and the client 200 has many advantages.

Client-Side Data Handling

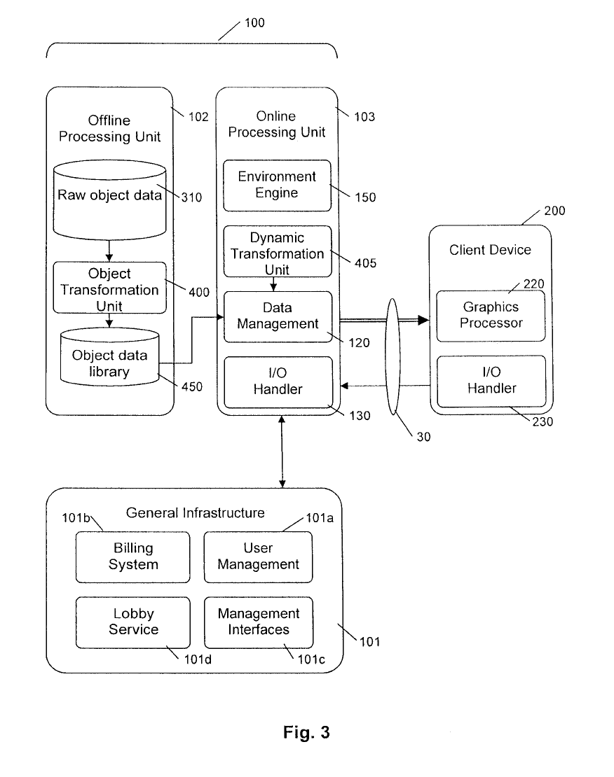

FIG. 4 is a schematic diagram showing the example client device 200 in more detail.

As discussed above, the client device 200 suitably includes at least a graphics processor unit 220 and an I/O handler 230. The I/O handler unit 230 handles network traffic to and from the server 100, including requesting data from the server 100 as required by the client device 200. The received data suitably includes compressed object data as described herein, which is passed to a data management unit 240 to be stored in a local storage device, e.g. in a relatively permanent local object library and/or a temporary cache 245. Suitably, the stored objects are retrieved from the cache or library 245 when needed, i.e. when these objects will appear in a frame or scene that is to be rendered at the client device 200. Conveniently, in some embodiments, the objects may be delivered to the client device in advance and are then released or activated by the server device to be used by the client device.

In this example embodiment, the client device 200 further comprises an object regeneration unit 250. The regeneration unit 250 is arranged to recreate, or regenerate, a representation of the object in a desired format. The recreated data may be added to the object library 245 to be used again later. A renderer within the graphics processor unit 220 then renders this recreated representation to provide image frames that are output to the visual display unit 210 within or associated with the client device 200. Suitably, the recreated data is a polygon mesh, or a texture, or an image file.

The client device 200 comprises a client-side environment engine 260. Suitably, this environment engine 260 controls the graphical environment in response to inputs from a user of the client device. That is, in a gaming system, the environment engine may be implemented by application code executing locally on the client device to provide a game that is displayed to the user via the display device 210. In the example embodiment, some parts of the game are handled locally by the client-side environment engine 260 while other parts of the game are handled remotely by the server-side environment engine 150 discussed above.

Typically, a game will include many segments of video which are played back at appropriate times during gameplay (e.g. cut scenes). In the example embodiments, these video sequences are dealt with locally using any suitable video-handling technique as will be familiar to the skilled person. These video sequences in games typically do not allow significant player interaction. Also, a game will typically include many audio segments, including background music and effects. In the example embodiments, the audio segments are dealt with using any suitable audio-handling technique as will be familiar to the skilled person.

In the example embodiments, the user of the client device 200 is able to begin playing a game relatively quickly. In particular, the example embodiments allow the object data to be downloaded to the client device including a minimum initial dataset sufficient for gameplay to begin. Then, further object data is downloaded to the client device 200 from the server 100 to allow the game to progress further. For example, in a car racing game, an initial dataset provides objects for a player's car and scenery in an immediate surrounding area. As the player or players explore the displayed environment, further object data is provided at the client device 200.

Synchronisation and Data Dependency

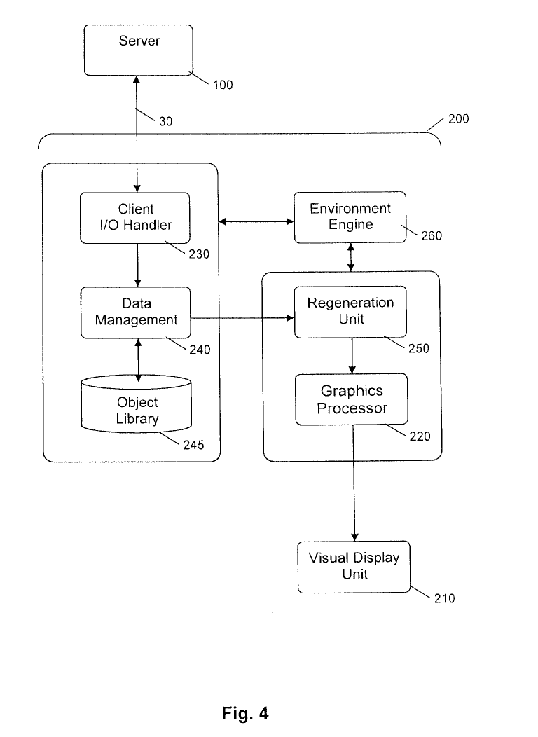

FIG. 5 is a schematic view showing the example system when performing rendering synchronisation and data dependency operations. As noted above, it is desired to deliver the graphical objects to the client device with minimal delay or latency, while maintaining efficient use of bandwidth. Thus, the example embodiments as discussed herein are provided with advanced data management and cache management mechanisms.

As shown in FIG. 5, the server 100 comprises the data management unit 120 which is arranged to schedule delivery of assets from the library 450 across the network 30 to the client 200, according to an asset dependency structure 452. This structure 452 defines dependencies between the assets. Particularly, the structure 452 defines dependencies between one object and another object, e.g. that a car body geometry model is linked to a geometry model of car wheels or a towed trailer. Similarly, the structure 452 defines dependencies within objects, e.g. between the car body geometry and one or more textures 600a, 600b. Thus, the structure 452 defines dependencies between the assets which will be needed by the graphics processor 220 at the client device 200 to render the objects onscreen.

An initial set of assets is provided to the client device, e.g. in a start-up download package. In the example embodiments, the start-up package is relatively small and requires only those objects which are to be visible to the user onscreen in an initial scene. For example, in a car racing game, only the car itself and scenery objects that immediately surround a start line need to be included in the start-up package.

As the environment progresses at the client device 200, further frames are determined and rendered, usually dependent upon user inputs and interactions between objects—e.g. the user presses “ACCELERATE” to move the car forward. The client-side environment engine now delivers a feedback stream to the server 100, which informs the server of progress in the virtual environment for this particular client device 200.

In the example embodiments, the server-side environment engine 150 creates a virtual or shadow representation of the scene being viewed on the client device. That is, the server-side environment engine 150 performs a shadow rendering function similar to the rendering being performed at the client-side environment engine 260. Conveniently, the shadow rendering is performed at a lower resolution (pixels per frame) and/or a lower frame rate (frames per second) than at the client device, thereby minimising processing requirements at the server. The server 100 thus obtains an index render which is consistent with the render as performed at the client device 200.

The shadow rendering process produces shadow rendering information which, inter alia, allows the server 100 to determine the objects which are, or are not, visible onscreen at the client device 200. The shadow rendering information may further indicate the relative importance of the displayed assets, e.g. with reference to a size of the asset on the screen or a relative distance from the current point of view. The server-side data management unit 120 may now tailor the delivery of the assets according to the determined shadow rendering information. In the example embodiment, the server-side data management unit 120 is arranged to adjust priorities assigned to graphical assets according to the determined shadow rendering information.

For example, a particular object may be included in a scene but is current obscured, e.g. hidden behind a player character or non-player character (NPC) at the current viewpoint. In response, even though the client device may request textures for this object, the server is able to determine that delivery of this texture may be delayed, or given a lower priority, without affecting the user's current view of the scene. As another example, the object may be visible but is relatively distant in the scene from the current point of view. Thus, a low resolution texture is sufficient (e.g. 64×64 pixels) for the object at this point in time. Where the relative position of the object then changes, the shadow rendering process now determines that a higher-resolution texture is (or soon will be) needed at the client device, such as a detailed image at 1024×1024 pixels. Importantly, the shadow rendering information allows the data management unit 120 to better utilise the available bandwidth. It will be appreciated that the data management function allows existing assets to be upgraded and new assets o be supplied over time as the virtual environment evolves. In a further enhancement, the shadow rendering information may also be used to delete redundant assets from the cache at the client device, allowing the virtual environment to run with a smaller footprint.

In a first example embodiment, the feedback stream sent from the client device may contain only user input actions. The server-side environment engine 150 executes a shadow version of the client-side environment engine 260, i.e. a synchronised version of the game as running on the client device. The user actions thus affect the virtual environment simultaneously at the client device and at the server to produce corresponding responses. These responses are rendered in full at the client device, and are shadow rendered at the server as noted above.

In a second example embodiment, the client 200 sends state information to the server 100 as an abstraction of the user responses and representing a current state of the virtual environment. For example, the state information may comprise elements in a list which identifies those assets which are being actively used to generate the images on screen, e.g. which texture file is currently being used in the current frame. This state information may be extracted from the graphics handling unit (graphics card) at the client device. The state information may be a list of objects currently received at the client device with a “on”/“off” indication as to whether that object is currently rendered onscreen, and similarly a texture file list may identify the used or unused texture files as a binary state. The server 100 may now update the shadow rendering function according to the received state information, and perform the data management as discussed above.

In a third example, the client device 200 performs intermittent client-side index rendering and sends the rendering information to the server 100 as the state information. Intermittently, frames selected from the full-scale rendering at the client 200 may be processed at the client device to produce the rendering information. Thus the server 100, or alternately the client 200, now determines which object, or chunks, of graphical data are now needed at the client device 200. The server 100 determines the delivery priorities accordingly.

The hybrid system discussed herein is leaner and more efficient. The server can be implemented with regular hardware without requiring specific support for graphics (e.g. because a separate server-side GPU is not required). Meanwhile, the client device requires only minimal start-up data, which may be downloaded with minimal delay. The client does not need to store large amounts of assets, because these assets are streamed from the server as needed. Further, asset delivery is efficiently managed to keep within available bandwidths.

Object Data Using PDEs

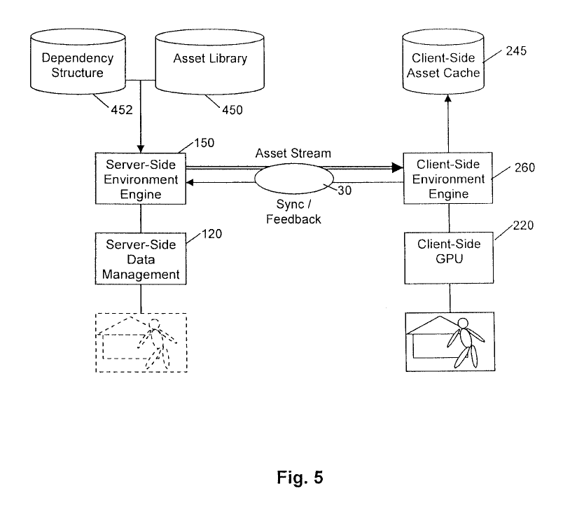

FIG. 6 is a schematic view showing an example embodiment of the object data assets in more detail. Geometry data and image data (particularly textures) are both provided in compressed formats as coefficients of a solution to a partial differential equation (PDE). This compression mechanism is discussed in more detail in published PCT application WO2011/110855 (Tangentix Limited), the entire disclosure of which is incorporated herein by reference.

In this example, object data 310 is provided comprising a set of volumetric geometry data 320 and/or a set of texture data 330. The object data is suitably provided in a compressed format as compressed object data 350, including compressed object geometry data 360 and/or compressed object image data 370. The compressed object geometry data 360 and/or compressed object image data 370 may comprise coefficients of a solution to a partial differential equation.

It is widely known to use polygon representations of 3D objects, covered with two-dimensional images or textures. Typically, the 3D object is represented in 3D space based on a geometric object, like a mesh or wire frame, which may be formed of polygons. Conveniently, these polygons are simple polygons such as triangles. There are many well-known specific implementations of polygon representations as will be familiar to those skilled in the art, and high-speed, high-performance dedicated hardware for handling polygon mesh representations is well known and widely available, such as in graphics cards, GPUs, and other components. However, polygon representations have a number of disadvantages. For example, polygon representations are relatively large, especially when finely detailed object geometry is desired, with each object taking several Mb of storage. Hence, polygon representations are difficult to store or transmit efficiently.

In the example embodiments, any given high resolution geometry mesh model is compressed into a set of surfaces representing the solution to a Partial Differential Equation (PDE). These are known in the art as PDE surfaces or PDE surface patches.

Further background information concerning PDE surface patches is provided, for example, in US2006/170676, US2006/173659, US2006/170688 (all by Hassan UGAIL), the entire disclosure of which is incorporated herein by reference.

Transforming the 3D object provides a mechanism through which an object which is originally represented by a high resolution mesh can be stored or transmitted efficiently, and then reproduced at one or more desired resolution levels. At the same time, the mechanism reduces the size of the information required to reproduce the model in different environments, where the object is recreated at or even above its original resolution.

This example uses PDE surfaces arising from the solution to a partial differential equation, and suitably an elliptic partial differential equation. As one option, the biharmonic equation in two dimensions is used to represent each of the region into which the original model is divided. The biharmonic equation leads to a boundary value problem, which is uniquely solved when four boundary conditions are specified. Analytic solutions to the biharmonic equation can be found when the set of boundary conditions are periodic, leading to a Fourier series type solution. Therefore, a set of four boundary conditions is provided for each of the regions composing the object, then this set is processed and the analytic representation of the region is found. Given that the same type of equation is used to represent each of the regions composing the object, the full object is characterized by a set of coefficients, which are associated with the analytic solution of the equation in use. The equation is solved in two dimensions, such as u and v, which are regarded as parametric coordinates. These coordinates are then mapped into the physical space (3D volume).

Texture data commonly includes an image file of a suitable format. Popular examples in the art include PNG, GIF or JPEG format files. Typically, this flat (2D) image is associated with a set of normal vectors that define a surface displacement of the image over an underlying three-dimensional structure of the 3D object. These textures are usually anchored to the geometric structure using texture coordinates which define a positional relationship of the texture image over a surface of the object. Texture normals may be distributed at intervals over the area of the texture image to provide detailed localised displacements away from the standard plane of the image. These normals are usually employed when rendering a final image (e.g. using ray-tracing techniques) to give a highly realistic finished image with effects such as shading and highlighting.

Textures are typically relatively large in size. In practice, the textures may be about 80% of the total data volume for a given object, while the geometry data is only about 20% of the total data. The example embodiments use PDEs to encode the image into a compressed form. In one example, the texture transformation mechanism uses a number of nested PDEs to allow the information to be placed where most needed.

FIG. 6 is a schematic diagram showing the original object data 310 and the transformed object data 350 as discussed above. In the example embodiments, the original object data 310 includes the original object geometry data 320 and/or the object image data (textures) 330 as mentioned above. The object transformation unit 400 transforms the object geometry data 320, which is suitably in a polygon mesh format, i.e. an original polygon mesh 510, into the compressed object geometry data 360 comprising coefficients 540 of a solution to a partial differential equation. These geometry coefficients 540 relate to a plurality of patches 530, which are suitably PDE surface patches. Meanwhile, the object transformation unit 400 transforms the object image data 330, which may comprise images 600 in a pixel-based format, to produce the compressed object image data 370 comprising coefficients 606 of a solution to a partial differential equation. These image coefficients 606 relate to a plurality of PDE texture patches or PDE image patches 630. Suitably, the coefficients 540, 606 include a mode zero and one or more subsequent modes. In this case there are eight modes in total for the coefficients relating to each patch.

Security/Anti-Piracy

The example embodiments address significant issues which arise in relation to the security of game data and avoiding unauthorised distribution of a game (piracy). Data security is an important feature in the field of multimedia distribution generally and many approaches to digital rights management have already been developed.

With progressively more PDE modes available, a regenerated object becomes progressively more detailed and a better approximation of the original object is achieved. It has been found that, by selectively removing at least the zero mode, the regenerated object becomes significantly impaired. Thus removing the zero mode for at least one of the object geometry data 3670 and/or the object image data 370 is an effective measure to improve security and to combat piracy.

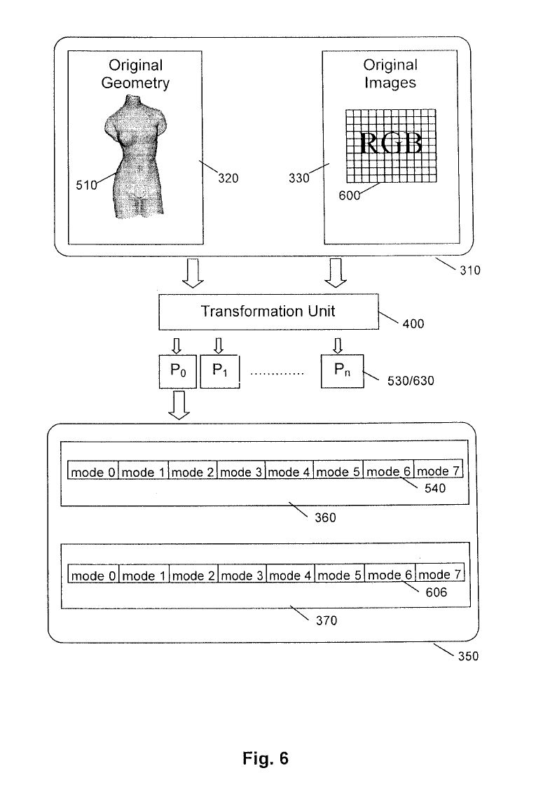

FIG. 7 shows an example secure multimedia content distribution system. In this example, removing the mode zero data 540a enables significant improvements in the secure distribution of a game. For example, significant quantities of object data relating to the lesser, subsequent modes 540b may be distributed in a relatively insecure distribution channel 30b. Meanwhile, the mode zero coefficients 540a for this object data are distributed to the client device 200 only through a secure distribution channel 540a. For example, the secure distribution channel 540a uses strong encryption and requires secure authentication by the user of the client device 200. Many specific secure and insecure distribution channels will be familiar to those skilled in the art, and the details of each channel will depend on the specific implementation. The lesser modes 540b in the main channel 30b may even be copied and distributed in an unauthorised way, but are relatively useless until the corresponding mode zero data 540a is obtained and reunited therewith. As one of the many advantages, this mechanism significantly reduces the quantity of data to be distributed through the secure channel 30a. Thus, new users can be attracted by providing mode zero data 540a for a sample or trial set of game data, while maintaining strong security for other game data to be released to the user later, such as after a payment has been made.

The client device 200 is suitably arranged to store at least the mode zero in a secure temporary cache 245. This cache is suitably cleared, e.g. under instructions from the server 100, at the end of a gameplay session. Meanwhile, other data, such as the other modes, may be maintained in a longer-term cache or library to be used again in a subsequent session, thus avoiding the need for duplicate downloads while maintaining security.

Bandwidth Management

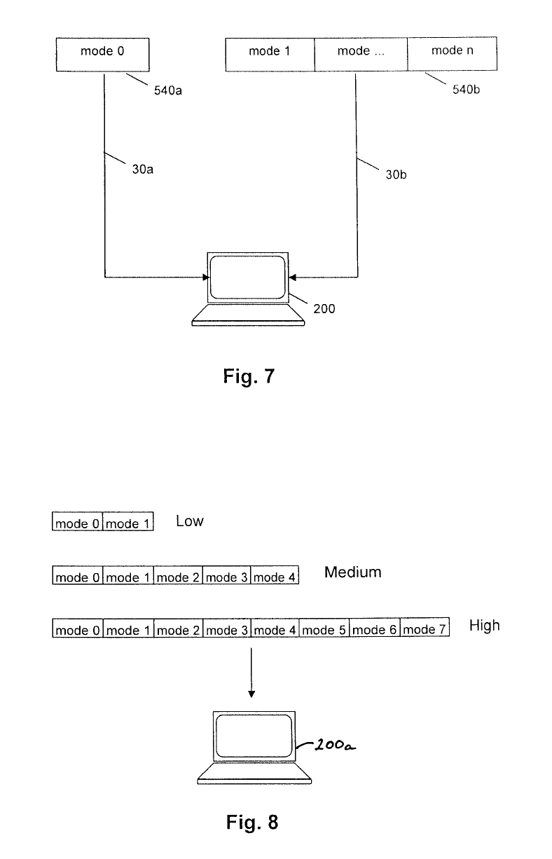

FIG. 8 shows a further aspect of the example multimedia content distribution system for managing bandwidth. In this example embodiment, the data management unit 120 of the server 200 is arranged to control distribution of the compressed object data 350 to the client device 200 with improved bandwidth management. In this case, it is desired to maximise and control the outgoing bandwidth available at the server 100. Also, it is desired to adapt to the available incoming bandwidth at the client devices 200.

In the example embodiments, the server 100 provides the coefficients 540 in the various modes according to a connection status or connection level with the client device 200. Conversely, in some example embodiments, the client device 200 is arranged to request the coefficients from the server 100 at one of a plurality of predetermined levels of detail.

Thus, for a low-bandwidth communication with a particular client device 200a, the server 100 sends, or otherwise makes available, suitably only the higher-order (most important) modes 540, which suitably includes at least the mode zero data 540. This first group of one or more modes allows the client device 200 to regenerate the objects at a first level of resolution, which may still be acceptable for playing the game. For a medium-bandwidth connection, the modes 540 are made available to the client device 200 at a second level of detail, with this second level containing more modes than the first level. At the highest connection level, a maximum number of modes are made available to the client device 200, allowing the client device to achieve a highest resolution in the regenerated objects. This principle can also be extended in also sending the additional or ancillary data relating to the objects at different levels, such as by sending image offsets at different levels of detail.

The sever 100 is now better able to manage the available outgoing bandwidth to service multiple users simultaneously and cope with varying levels of demand. Further the server 100 is able to satisfy a user at each client device 200 to provide acceptable levels of gameplay appropriate to the incoming bandwidth or connection currently available for that client device 200. In many cases, a (perhaps temporary) drop in resolution is to be preferred over a complete loss of gameplay while waiting for high-resolution objects to arrive. Thus, the client device 200 is better able to continue gameplay without having to pause. Also, the system is able to service a wide constituency of client devices 200 from the same source data, i.e. without needing to host multiple versions of the game data.

As a further refinement, objects within the environment may be assigned different priorities. For example, an object with a relatively high priority (such as a player character or closely adjacent scenery) is supplied to the client device 200 with relatively many modes, similar to the high connection level, and is thus capable of being regenerated at a high resolution, while an object with a relatively low priority (e.g. a distant vehicle or building) is delivered to the client device 200 with relatively few modes, i.e. at a low level, to be regenerated at relatively low resolution.

### INDUSTRIAL APPLICATION

The invention as described herein may be industrially applied in a number of fields, including particularly the field of delivering multimedia data (particularly graphical objects) across a network from a server device to client device.

The example embodiments have many advantages and address one or more problems of the art as described above. In particular, the example embodiments address the problem of serving many separate client devices simultaneously with limited resources for the server and/or for bandwidth, which are particularly relevant with intensive gaming environments. The example embodiments address piracy and security issues. The example embodiments also allow dynamic resolution of objects, in terms of their geometry and/or textures, within a virtual environment.

At least some of the example embodiments may be constructed, partially or wholly, using dedicated special-purpose hardware. Terms such as ‘component’, ‘module’ or ‘unit’ used herein may include, but are not limited to, a hardware device, such as a Field Programmable Gate Array (FPGA) or Application Specific Integrated Circuit (ASIC), which performs certain tasks.

Elements of the example embodiments may be configured to reside on an addressable storage medium and be configured to execute on one or more processors. That is, some of the example embodiments may be implemented in the form of a computer-readable storage medium having recorded thereon instructions that are, in use, executed by a computer system. The medium may take any suitable form but examples include solid-state memory devices (ROM, RAM, EPROM, EEPROM, etc.), optical discs (e.g. Compact Discs, DVDs, Blu-Ray discs and others), magnetic discs, magnetic tapes and magneto-optic storage devices.

In some cases the medium is distributed over a plurality of separate computing devices that are coupled by a suitable communications network, such as a wired network or wireless network. Thus, functional elements of the invention may in some embodiments include, by way of example, components such as software components, object-oriented software components, class components and task components, processes, functions, attributes, procedures, subroutines, segments of program code, drivers, firmware, microcode, circuitry, data, databases, data structures, tables, arrays, and variables.

Further, although the example embodiments have been described with reference to the components, modules and units discussed herein, such functional elements may be combined into fewer elements or separated into additional elements.

Although a few example embodiments have been shown and described, it will be appreciated by those skilled in the art that various changes and modifications might be made without departing from the scope of the invention, as defined in the appended claims.

1. A system for delivering graphical information across a network between a server and a client device, the system comprising:
an asset library at the server which stores object data relating to a plurality of objects;
a data management unit at the server which in use transmits the object data from the asset library to the client device across the network;
a server-side environment engine at the server which monitors a virtual environment being presented at the client device, wherein the virtual environment comprises one or more of the plurality of objects based on the object data transmitted to the client device;
a client-side environment engine at the client device which receives the object data from the data management unit and uses the object data within the virtual environment as represented at the client device; and
a client-side graphics processor which renders and outputs a sequence of image frames to represent the virtual environment on a visual display device associated with the client device;
wherein the data management unit is arranged to provide an initial set of the object data sufficient for the client device to begin representing the virtual environment, followed by one or more subsequent items of the object data dynamically while the client device represents the virtual environment on the visual display device;
wherein the server-side environment engine maintains shadow rendering information regarding the virtual environment as presented at the client device, wherein the shadow rendering information identifies the object data being used to render the virtual environment at the client device; and
wherein the data management unit prioritises delivery of the subsequent items of object data to the client device with reference to the shadow rendering information.

2. The system of claim 1, wherein the shadow rendering information at the server tracks progress of the virtual environment as represented by the client device.

3. The system of claim 1, wherein the server-side environment engine performs a rendering function to create the shadow rendering information.

4. The system of claim 3, wherein the server-side environment engine performs the rendering function to create the shadow rendering information at one or both of a lower resolution and a lower frame rate than the render performed by the client-side graphics processor.

5. The system of claim 3, wherein the rendering function of the server-side environment engine is synchronised with the render by the client-side graphics processor.

6. The system of claim 3, wherein the server-side environment engine and the client-side environment engine each update the virtual environment in response to user commands received at the client device, the user commands being provided in a return stream from the client device to the server.

7. The system of claim 1, wherein the client device performs intermittent index rendering and sends rendering information to the server which updates the shadow rendering information at the server.

8. The system of claim 1, wherein the client device provides state information to the server representing a current state of the virtual environment as rendered by the client device, and the server-side environment engine updates the shadow rendering information based upon the state information.

9. The system of claim 1, wherein the shadow rendering information identifies objects which are visible onscreen in the virtual environment as represented at the client device.

10. The system of claim 1, wherein the shadow rendering information identifies a relative importance of the objects in the virtual environment.

11. The system of claim 10, wherein the relative importance identifies a relative size of the object or a relative position of the object with respect to a current point of view of the virtual environment.

12. The system of claim 10, wherein the server-side environment engine unit selects a first of the items of object data from the asset library when the object has a low relative importance and selects a second of the items of object data when the object has a high relative importance.

13. The system of claim 1, wherein the system further comprises an asset dependency structure which defines dependencies between the object data stored in the asset library, and the subsequent items of object data are selected from the asset library with reference to the asset dependency structure.

14. The system of claim 1, wherein the object data includes geometry data and/or texture data relating to three-dimensional objects.

15. The system of claim 1, wherein the server-side environment engine generates commands which inform the client device how to display the object data in the virtual environment.

16. The system of claim 1, wherein the server-side environment engine performs artificial intelligence functions which determine progress of the virtual environment as represented at the client device.

17. The system of claim 1, wherein the virtual environment is a game environment.

18. A method for delivering graphical information across a network from a server apparatus to a client device, the method comprising:
providing an initial set of object data sufficient for the client device to begin representing a virtual environment on a visual display device,
providing one or more subsequent items of the object data dynamically while the client device represents the virtual environment on the visual display device;
maintaining shadow rendering information at the server which identifies the object data currently being used to present the virtual environment at the client device; and
determining a relative priority of the one or more subsequent items of object data which are to be delivered to the client device with reference to the shadow rendering information.

19. The method of claim 18, further comprising performing a rendering function at the server to create the shadow rendering information, wherein the rendering function is synchronised with a render of the virtual environment at the client device.

20. A tangible non-transient computer readable medium having recorded thereon instructions which when executed by a computer cause the computer to perform the steps of:
providing an initial set of object data sufficient for the client device to begin representing a virtual environment on a visual display device,
providing one or more subsequent items of the object data dynamically while the client device represents the virtual environment on the visual display device;
maintaining shadow rendering information at the server which identifies the object data currently being used to present the virtual environment at the client device; and
determining a relative priority of the one or more subsequent items of object data which are to be delivered to the client device with reference to the shadow rendering information.
